(19) United States
(12) Patent Application Publication
(10) Pub. No.: US 2001/0004591 A1
(43) Pub. Date: Jun. 21, 2001

(54) Method for controlling phone-locking of mobile communication terminal

(75) Inventor: Ho Joong Jeong, Seoul (KR)

Correspondence Address: FLESHNER & KIM, P.O. Box 221200, Chantilly, VA, 20153-1200, US

(73) Assignee: LG Electronics Inc.

(21) Appl. No.: 09/738,984

(22) Filed: Dec. 19, 2000

(30) Foreign Application Priority Data
Dec. 21, 1999 (KR) 59602/1999

(51) Int. Cl. H04M 3/00; H04Q 7/20

(52) U.S. Cl. 455/419; 455/411; 455/422

(57) ABSTRACT

A method for controlling phone-locking of a mobile communication terminal which is capable of preventing a stranger from using freely a user's terminal in case that the user's terminal is lost in a state that a phone locking function of the terminal has not been set. The method for controlling phone-locking of a mobile communication terminal includes the steps of: receiving a phone-locking request signal form a user; transmitting an order message for phone-locking to a lost terminal, when the phone-locking request signal is received; and setting a phone-locked state for the lost terminal according to the transmitted order message for phone-locking.

### BACKGROUND OF THE INVENTION

1. Field of the Invention

The present invention relates to a mobile communication terminal, and more particularly to a method for controlling phone-locking of a mobile communication terminal.

2. Description of the Background Art

These days, thanks to its portability and convenience, a mobile communication terminal (referred to as ‘terminal’, hereinafter) is used by lots of people. The terminal provides users with various functions, such as inputting of a contact place, telephone numbers, itinerary management or memos, so that, presently, it serves even as a means for managing personal information as well as having its original function of a simple telephone communication.

The terminal has various restriction functions, one of which is a phone-locking function is a function for restricting other persons than a user from using a terminal. The user sets a phone-locked state by inputting a phone-locking setting password on the basis of selection menus provided on the terminal. Once the phone-locking function is set, the terminal only serves to take a call.

When the user releases the phone-locked state of the corresponding terminal by using the phone-locking setting password to make a phone call or check user information stored in the terminal.

Accordingly, even if the terminal is lost, since the terminal having such a phone-locking function, a stranger or other persons are not able to make free use of the terminal or drain out personal information of the user.

In this respect, however, in case that the terminal is lost in a state that its phone-locking function has not been set, there is a high possibility that a stranger makes free use of the user's terminal, and most of all, information, such as a contact place, a phone number, memos of the user, can be drained out.

### SUMMARY OF THE INVENTION

Therefore, an object of the present invention is to provide a method for controlling phone-locking of a mobile communication terminal which is capable of preventing a stranger from using freely a user's terminal in case that the user's terminal is lost in a state that a phone locking function of the terminal has not been set.

To achieve these and other advantages and in accordance with the purpose of the present invention, as embodied and broadly described herein, there is provided a method for controlling phone-locking of a mobile communication terminal including the steps of: receiving a phone-locking request signal from a user; outputting a control signal for setting a phone-locked state to a lost terminal when the phone-locking request signal is received; and setting a phone-locked state for the lost terminal according to the phone-locking control signal.

In order to achieve the above object, there is also provided a method for controlling phone-locking of a mobile communication terminal including the steps of: receiving a control signal for phone-locking; searching a memory region to read a phone-locking setting password, when the control signal for phone-locking is received; and setting a phone-locked state by using the read phone-locking setting password.

In order to achieve the above object, there is also provided a method for controlling phone-locking of a mobile communication terminal including the steps of: receiving a phone-locking request signal form a user; transmitting an order message for phone-locking to a lost terminal, when the phone-locking request signal is received; and setting a phone-locked state for the lost terminal according to the transmitted order message for phone-locking.

In order to achieve the above object, the step of setting a phone-locked state of the method for controlling phone-locking of a mobile communication terminal including the sub-steps of: receiving an order message; checking whether the received order message is a message for phone-locking or a general message; reading a password from a memory in case that the order message is a message for phone-locking; enabling a variable value for phone-locking; and outputting a reset command to a system task to re-boot the terminal.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a schematic view of a mobile communication system in accordance with the present invention;

FIG. 2 is a signal flow chart for setting a phone-locked state for a lost terminal of FIG. 1 in accordance with the present invention;

FIGS. 3A and 3B illustrate formats of an order message transmitted from a system provider to the lost terminal for setting a phone-locked state of FIG. 2 in accordance with the present invention; and

FIG. 4 is a flow chart of a method for setting a phone-locked state performed in the lost terminal in accordance with the present invention.

### DETAILED DESCRIPTION OF THE PREFERRED EMBODIMENTS

Reference will now be made in detail to the preferred embodiments of the present invention, examples of which are illustrated in the accompanying drawings.

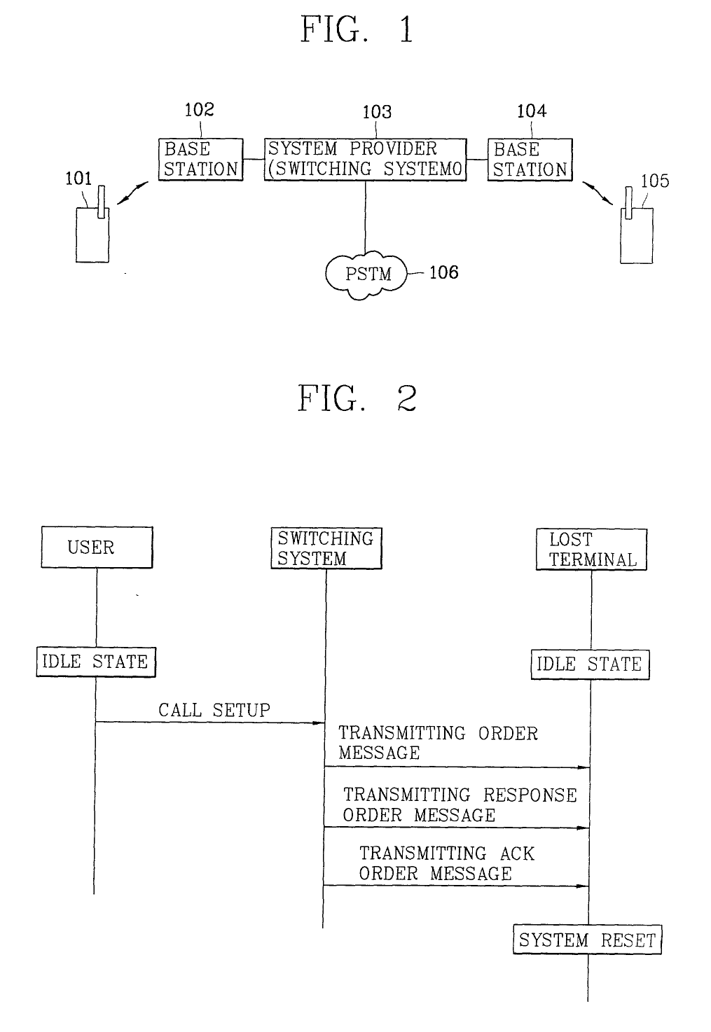

FIG. 1 is a schematic view of a mobile communication system in accordance with the present invention, and FIG. 2 is a signal flow chart for setting a phone-locked state for a lost terminal of FIG. 1 in accordance with the present invention.

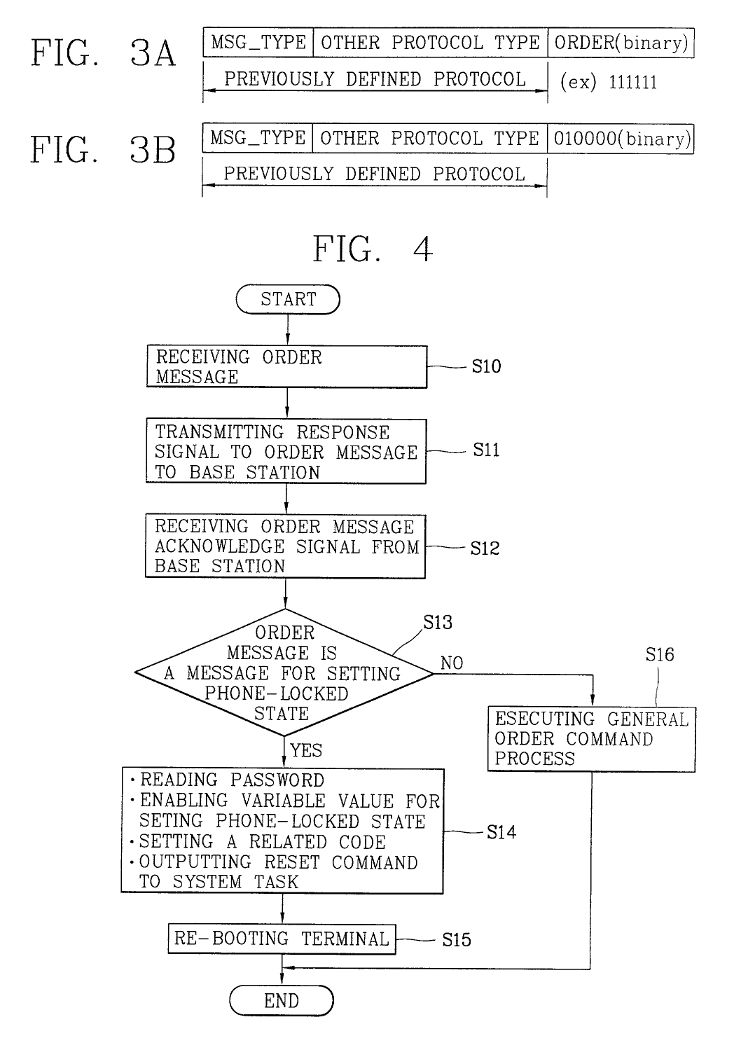

As shown in the drawings, when a terminal 105 is lost in a state that a phone-locking function has not been set, the user reports to a system provider 103 that he or she has lost the terminal and requests a phone-locking service (S1). Upon receipt of the request for a phone-locking service, a switching system of the system provider 103 transmits an order message for radio phone-locking as shown in FIG. 3A through a base station 104 to the terminal 105 (S2).

On the other hand, instead of requesting phone-locking to the system provider 103, the user may directly accesses a program set by the system provider 103 by using a network and automatically transmits an order message to the terminal 105 by using a phone-locking function set in the program.

After the switching system of the system provider 103 transmits the order message to the terminal 105, it waits for a response signal as shown in FIG. 3B to the order message from the terminal 105. If no response signal is received from the terminal 105, the switching system of the system provider 103 repeatedly transmits the order message to the terminal 105 for a predetermined number of times.

Meanwhile, in case that a response signal that the order message has been successfully received is received from the terminal 105 (S3), the switching system transmits an order message acknowledge signal as shown in FIG. 3B, that is, a phone-locking acknowledge signal, to the terminal 105 (S4). In this respect, the order message acknowledge signal has the same form as the response signal. Then, the terminal 105 sets a phone-locked state according to a code value of an order specific field of the received order message and resets its system.

The operation for setting a phone-locked state will now be described with reference to FIG. 4.

When an order message (paging/Forward channel) is received from the base station 104 (S10), the terminal 105 transmits a previously defined order message response signal as shown in FIG. 3B to the base station 102 (S11).

Upon receipt of the order message response signal from the terminal 105, the base station 104 transits the order message acknowledge signal as shown in FIG. 3B to the terminal 105 to acknowledge a phone-locking operation (S12).

Accordingly, transmitting and receiving of a basic protocol between the switching system and the terminal 105 are terminated, and the terminal 105 searches the content of the order specific field of the received order message and performs operation of the related code.

First, the terminal 105 checks whether the received order message is a command for wireless phone-locking or a general order command (Paging/Forward channel) (S13). The order message for wireless phone-locking includes a message type (MSG_TYPE) field, an other protocol type field, which are previously defined protocol, and an order specific field which is added thereto.

Accordingly, the terminal 105 checks whether the code value of the order specific field of the order message is ‘111111’ or not to thereby recognize a command for wireless phone-locking.

Upon checking, in case that the code value of the order specific field is set as ‘111111’, the terminal 105 reads a previously stored password (phone-locking password) from the memory and enables a variable value for setting a phone-locked state. And then, the terminal 105 sets a related code and transmits a reset command to the task (S14).

Meanwhile, in case that the user has not set a password for phone-locking or in case that a set password is ‘0000’, the terminal 105 sets and stores the back four digits of the user's phone number as a password to be used by the user for releasing phone-locking, and then re-boots the system.

Meanwhile, in the step S13, in case that the order message is a general order command (Paging/Forward channel), the terminal 105 executes a general order command process.

Accordingly, after the system is reset, the state of terminal 105 is changed to a phone-locked state, a stranger is not able to use the terminal 105 or drains out personal information of the user unless he or she know the phone-locking setting password as set by the user.

As so far described, according to the method for controlling phone-locking of a mobile communication terminal, in case that a terminal is lost, an order message for setting a phone-locked state is transmitted from the mobile communication service provider to the lost terminal, so that the state of the terminal is set as a phone-locked state.

Therefore, even in case that a mobile communication terminal with its phone-locking function not set is lost, making use of the terminal by a stranger and draining out of the user's personal information can be effectively prevented.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the meets and bounds of the claims, or equivalence of such meets and bounds are therefore intended to be embraced by the appended claims.

What is claimed is:

1. A method for controlling phone-locking of a mobile communication terminal comprising the steps of:
receiving a phone-locking request signal form a user;
transmitting an order message for phone-locking to a lost terminal, when the phone-locking request signal is received; and
setting a phone-locked state for the lost terminal according to the transmitted order message for phone-locking.

2. The method according to claim 1, wherein the order message is transmitted from a mobile communication service provider through a base station to the lost terminal.

3. The method according to claim 1, wherein the step of transmitting an order message comprising the sub-steps of:
transmitting an order message to a lost terminal;
receiving a response signal to the order message from the lost terminal; and
transmitting an order message acknowledge signal to the lost terminal, when the response signal is received.

4. The method according to claim 3, wherein the order message is repeatedly transmitted for a predetermined number of times until a response signal is received.

5. The method according to claim 1, wherein the step of setting a phone-locked state comprising the sub-steps of:
receiving an order message from a base station;
checking whether the received order message is a message for phone-locking; and
reading a stored password, setting a phone-locked state and re-booting the terminal, in case that the received order message is a message for phone-locking.

6. The method according to claim 5, wherein the terminal executes a corresponding order command process in case that the received order message is a general order message.

7. The method according to claim 5, wherein the order message for phone-locking comprising:
a message type field;
an other protocol type field; and
an order specific field.

8. The method according to claim 5, wherein the terminal judges of the order message for phone-locking on the basis of the order specific field value of the order message.

9. The method according to claim 5, wherein in case that the user has not set a password for phone-locking or in case that a set password is ‘0000’, the terminal sets and stores the back four digits of the user's phone number as a password to be used by the user for releasing phone-locking.

10. A method for controlling phone-locking of a mobile communication terminal including the steps of:
receiving an order message;
checking whether the received order message is a message for phone-locking;
reading a password from a memory in case that the order message is a message for phone-locking; and
enabling a variable value for phone-locking.

11. The method according to claim 10, wherein the order message is transmitted from a mobile communication service provider through a base station to the lost terminal.

12. The method according to claim 10, wherein the order message for phone-locking comprising:
a message type field;
an other protocol type field; and
an order specific field.

13. The method according to claim 10, wherein the terminal judges of the order message for phone-locking on the basis of the order specific field value of the order message.

14. The method according to claim 10, wherein in case that the user has not set a password for phone-locking or in case that a set password is ‘0000’, the terminal sets and stores the back four digits of the user's phone number as a password to be used by the user for releasing phone-locking.

15. A method for controlling phone-locking of a mobile communication terminal comprising the steps of:
transmitting an order message to a lost terminal in case that a phone-locking request signal is received from a user; and
setting the state of the lost terminal as a phone-locked state according to the transmitted order message,
of which the step of setting a phone-locked state comprising the sub-step of:
receiving an order message;
checking whether the received order message is a message for phone-locking;
reading a password from a memory in case that the order message is a message for phone-locking; and
enabling a variable value for phone-locking.

16. The method according to claim 15, wherein the step of transmitting an order message comprising the steps of:
transmitting an order message to a lost terminal;
receiving a response signal to the order message from the lost terminal; and
transmitting an order message acknowledge signal to the lost terminal, when the response signal is received.

17. The method according to claim 15, wherein the order message for phone-locking comprising:
a message type field;
an other protocol type field; and
an order specific field.

18. The method according to claim 15, wherein the terminal recognizes the order message for phone-locking when the order specific field value of the order message is a predetermined value.

19. The method according to claim 15, wherein in case that the user has not set a password for phone-locking or in case that a set password is ‘0000’, the terminal sets and stores the back four digits of the user's phone number as a password to be used by the user for releasing phone-locking.
